(19) United States
(12) Patent Application Publication
(10) Pub. No.: US 2019/0162833 A1
(43) Pub. Date: May 30, 2019

(54) ULTRASONIC POSITION DETECTION SYSTEM

(71) Applicant: Fidelity Technologies Corporation, Reading, PA (US)

(72) Inventors: STANLEY JOSEPH CHAYKA, Manheim, PA (US); Eric Alan HUBER, Leesport, PA (US)

(21) Appl. No.: 16/094,964

(22) PCT Filed: Apr. 21, 2017
(86) PCT No.: PCT/US2017/028863

§ 371 Date: Oct. 19, 2018

Related U.S. Application Data
(60) Provisional application No. 62/326,363, filed on Apr. 22, 2016.

(51) Int. Cl. G01S 11/14; G01S 3/801; G01S 3/86; G03B 21/14; H04N 9/31

(52) U.S. Cl. CPC G01S 11/14; G01S 3/801; H04N 9/3147; G03B 21/14; G01S 3/86

(57) ABSTRACT

Tracking systems have been successfully applied to immersive simulation systems and virtual environment training in which portable devices (i.e., hand-held military equipment) within the immersive simulation system are tracked using time-of-fright recordings to triangulate each devices position. Until now, tracking systems have not used differential calculations to track these portable devices. The invention uses a single array of sensors mounted above the simulation area to communicate with small transmitters and emitters mounted on each portable device to generate position offsets for each portable device.

### FIELD OF THE INVENTION

Described herein are position detection (tracking) systems, and in particular ultrasonic position detection systems that utilize at least one stationary array-based ultrasonic receiver in combination with a portable ultrasonic transmitter to be tracked to provide a safe and robust position detection system.

### BACKGROUND OF THE INVENTION

This invention relates to a position tracking system. In an exemplary embodiment, the invention relates to an immersive simulation system which incorporates the position tracking system. More particularly, the invention relates to an immersive military simulation system which incorporates the position tracking system.

Most current ultrasonic tracking systems use “time-of-flight” from a series of stationary ultrasonic transmitters strategically placed around an area of interest and received by one or more portable devices in order to calculate the portable devices' positions. In a time of flight system, a portable device will receive an ultrasonic tone from multiple stationary transmitters and calculate the position of the portable device via triangulation of time-of-flight data from at least 2 ultrasonic transmitters.

Problems exist with ultrasonic time-of-flight tracking systems. For example, the ultrasonic transmitter side of the interface is usually incorporated into multiple stationary sensors. This requires that each stationary sensor be placed at strategic locations around the area of interest, and that these locations must be accurately measured and their location data inputted into tracking algorithms. This is a tedious task and not conducive to an immersive simulation system.

Another problem is that many time-of-flight portable entities are configured with microphones to detect the ultrasonic transmission. Microphones are susceptible to outside noise. They can overload or trigger false signals due to outside noise. Time-of-flight tracking systems are also susceptible to echoes from multiple ultrasonic signal paths. With multiple transmitters, determining an echo from a real transmission is difficult and sometimes impossible.

Many time-of-flight tracking systems use ultrasonic tones as a triggering mechanism to trigger the emittance of an ultrasonic tone from the stationary transmitters. Ultrasonic sound is subject to wind direction and speed, temperature, air density and air pressure across a sometimes large distance which could introduce a large amount of error.

The incorporation of tracking systems in immersive simulation systems is vital to creating a realistic virtual environment. If tracking systems were not incorporated into immersive simulation systems, for example the point-of-view for each portable device within the system would always be from the center of the area of interest in the system. If a portable device was moved off of center, the eye point offset of the image on the dome towards the orientation of the portable device would not match the portable device's simulated point of view.

Thus, it was the goal of the instantly described system to overcome the flaws noted above in “time of flight” ultrasonic tracking systems, while enabling a tracking system which could reasonably easily and effectively be integrated into a realistic virtual environment. The instantly disclosed tracking system was found to be able to overcome these problems with available “time of flight” tracking systems.

### BRIEF SUMMARY OF THE INVENTION

The instantly described system is an ultrasonic tracking system which utilizes a differential approach rather than a time of flight calculation to arrive at both the x-position and the y-position of the item being tracked. In another embodiment, the system also allows for tracking of z-position utilizing a time of flight calculation in combination with the calculated x-position and y-position. Finally, for example, this system may be incorporated into an immersive simulation system in order to track, for example, portable devices, such as simulated military devices in a simulated military environment. This system is described in more detail below, although the exemplary embodiments listed below are not intended to be limiting.

The instantly described system solves the problems of the previously used “time of flight” systems. For example, rather than requiring multiple stationary sensors which must be individually calibrated, the described system allows for performing of a one-time calibration routine at installation time. The calibration routine includes placing a portable device fitted with an ultrasonic emitter on the floor of the area of interest, directly under a sensor array installed in an immersive simulation system. To calibrate, the array would send a coded infrared burst to the portable device on the floor in which the portable device would respond with an ultrasonic tone. The information acquired from this exercise, is the distance to the floor in the Z axis as well as the X and Y offset readings at the center of the area of interest. To aid in finding the location directly under the present invention, a calibration laser is incorporated into the present invention to project a spot on the floor directly under the sensor array.

The instantly disclosed position tracking system uses a differential approach rather than time-of-flight triangulation. This allows, for example, placement of a single sensor array confined to a single point above the area of interest of an immersive simulation system. Portable devices, such as for example simulated military devices, include a transmitter which transmits an ultrasonic tone to the stationary sensor array. An ultrasonic tone can for example be a 40 KHz acoustic ultrasonic tone of a limited duration and a constant frequency. Each portable device's ultrasonic tone is captured by the sensors in the array and only using the difference in phase between the tone reaching each sensor to calculate a portable device's position.

The present invention may incorporate a resonant receiver which only detects a specific frequency of ultrasonic tone (for example 40 KHz). This creates a natural band pass filter, thus avoiding problems with more typical “time of flight” systems with overload or false signals due to extraneous noise.

The present invention allows situations in which only one portable device transmits a single ultrasonic tone at a time to one sensory array, thus avoiding problems present in “time of flight” systems due to interference making difficult the detection of an echo.

The present invention a signal produced from at least one emitter, for example a radio transmission or an infrared burst, as a triggering mechanism to reduce error due to wind direction and speed, temperature, air density and air pressure across a sometimes large distance. Also, the present invention's sensor array only measures phase differentials across the same cycle of a wave of an ultrasonic tone. This close proximity reduces the chance of atmospheric conditions affecting position detection.

In one exemplary embodiment, the system configures portable devices (for example hand-held simulated military equipment) with one ultrasonic transmitter and a stationary sensor array with at least three (3) ultrasonic sensors. The ultrasonic sensors are configured, for example, in a perpendicular “L” configuration (FIG. 1) so as to collect and calculate both X and Y axis positions.

The stationary sensor array may for example be placed above the center of an immersive simulation system (for example a dome), and no sensor array location measurements need to be taken or inputted into tracking algorithms. All required measurements can be automatically calculated during the simple calibration since the sensor array sensors are spaced at a known distance.

In an embodiment, a portable device fitted with an ultrasonic transmitter is polled via a signal, for example a numeric infrared signal, to emit an ultrasonic tone or tone. As the tone is detected in the first of the sensors (for example the Reference Sensor in the center of the “L”) in the sensor array, a processor starts a period counter. As the tone is detected in the next sensor in the array, the counter value is noted and the difference is stored, for example in the storage of a computer configured to store positioning data. Finally, as the tone is detected in the third sensor in the array, the counter value is noted and the difference stored again. The phase detection differentials and the order of sensors detecting the tone are used to calculate the X and Y position of the portable device. Multiple detections may occur for each tone and could be used to average out the measured phase differentials.

In an embodiment, the ultrasonic tone emitted from a portable device, is also used in a time-of-flight algorithm to calculate the Z axis position. When a portable device is polled to emit an ultrasonic tone via an infrared burst, the sensor array processor starts a counter and stops the counter when a number of samples per tone reaches a sensor in the array. The median counter value is used along with the X and Y offsets from center to calculate the height above the floor (Z-axis).

In an embodiment, the present invention requires that each portable device be assigned a unique identifier known as a Tracking ID. The sensor array processor will cause the emitter (for example an infrared emitter) to transmit a single code (burst), containing a command and a Tracking ID (based on a prioritized scheduler), to all portable devices registered in the system. If the command dictates to emit an ultrasonic tone, only the portable device with the matching Tracking ID will emit the tone.

In an embodiment, the code transmitted to all portable devices is implemented as an infrared burst originating from the sensor array.

In an embodiment, the present invention, as it is desired for the final application, implements an accelerometer/gyroscope/compass device in order to detect a portable device's orientation. This device provides the yaw, pitch and roll of the device (3 degrees of freedom [3DOF]) and the present invention provides the X, Y and Z axis offsets from center. Together, they provide 6DOF capabilities (6 degrees of freedom). The position offsets (X, Y and Z) are combined with the 3DOF data to produce an adjusted 3DOF used as input into an immersive simulation system's display functionality to generate a display image from the portable device's eye point offset.

Additional exemplary embodiments include:

In a first embodiment, a system for tracking the location of a portable device, comprising: —a portable device comprising an ultrasonic transmitter and a detector; —a stationary sensor array comprising at least three ultrasonic sensors in communication with a sensor array processor; and —at least one emitter; wherein the at least one emitter is configured to send a signal to the portable device; wherein the portable device is configured to emit an ultrasonic tone when the detector receives the infrared burst; wherein the at least three ultrasonic sensors are configured to receive the ultrasonic tone; and wherein the sensor array processor is configured to calculate differentials and the order in which the at least three ultrasonic sensors receive the ultrasonic tone to calculate the x-position and the y-position of the portable device.

In a second embodiment, the system according to the first embodiment, wherein the sensor array processor is further configured to start a counter when the sensor array emits the signal and stop the counter when a number of samples per tone reaches a sensor in the array to determine the z-position of the portable device.

In a third embodiment, the system according to the second embodiment, wherein the portable device further comprises an accelerometer/gyroscope/compass device.

In a fourth embodiment, the system according to the first embodiment, wherein the stationary sensor comprises three ultrasonic sensors, comprising an x-axis sensor, a y-axis sensor, and a reference sensor.

In a fifth embodiment, the system according to the first embodiment, wherein the at least one emitter is located on the stationary sensor array.

In a sixth embodiment, an immersive simulation environment comprising the system according to the first embodiment.

In a seventh embodiment, the immersive simulation environment according to the sixth embodiment, wherein the immersive simulation environment is in the shape of a dome.

In an eighth embodiment, the immersive simulation environment according to the seventh embodiment, wherein the stationary sensor array is located at the top center of the dome.

In a ninth embodiment, the immersive simulation environment according to the sixth embodiment, wherein the immersive simulation environment is a simulated military environment.

In a tenth embodiment, the immersive simulation environment according to the ninth embodiment, wherein the portable device is a simulated military device.

In an eleventh embodiment, an immersive simulation system comprising the system according to the first embodiment, a dome, at least two rear-mounted image projectors, and at least two projector image generators, at least two SMD image generators, wherein the portable devices receive images from the SMD image generators.

In a twelfth embodiment, a method for tracking the position of a portable device comprising an ultrasonic transmitter and a detector in an immersive simulation system comprising a stationary sensor array comprising at least three ultrasonic sensors in communication with a sensor array processor, and at least one emitter; the process comprising: —sending a signal from the emitter to the portable device; —emitting an ultrasonic tone from the portable when the detector receives the signal; —receiving at the at least three ultrasonic sensors the ultrasonic tone; and —calculating in the sensor array processor phase differentials and the order in which the at least three ultrasonic sensors receive the ultrasonic tone to determine the x-position and the y-position of the portable device.

In a thirteenth embodiment, the method according to the twelfth embodiment, further comprising: starting a counter at the sensor array processor when the sensor array emits the signal and stopping the counter when a number of samples per tone reaches a sensor in the array to determine the z-position of the portable device.

In a fourteenth embodiment, the method according to the twelfth embodiment, wherein the immersive simulation system is in a dome, wherein the stationary sensor array is mounted at the top center of the dome, and the portable device is located inside of the dome.

In a fifteenth embodiment, the method according to the fourteenth embodiment, wherein the at least one emitter is on the stationary sensor array.

In a sixteenth embodiment, the method according to the fifteenth embodiment, wherein the stationary sensor array comprises three sensors, an x-axis sensor, a y-axis sensor, and a reference sensor.

In a seventeenth embodiment, the method according to the sixteenth embodiment, wherein the processor is programmed to record a multitude of timer values when the ultrasonic tone is sensed for each of the three ultrasonic sensors; and wherein the x-position and y-position calculation comprises: subtracting the x axis sensor timer value from the reference sensor timer value to create an x axis differential; subtracting the y axis sensor timer value from the reference sensor timer value to create a y axis differential; and applying a configurable scaling factor to the x-axis differential and the y-axis differential to determine x-axis and y-axis offsets for the portable device.

In further embodiments, the emitter is either an infrared emitter or a radio transmitter and the detector is either an infrared sensor or a radio detector.

In additional embodiments, the emitter is an infrared emitter and the detector is an infrared sensor.

### BRIEF DESCRIPTION OF THE DRAWINGS

Other features of the invention, as well as the invention itself, will become more readily apparent from the following detailed description when taken together with the accompanying drawings, in which:

FIG. 1 is a depiction of an embodiment of the system wherein an ultrasonic sensor array is shown. The sensor array is made up of the Y-axis sensor (102), the X-axis sensor (100) and the Reference sensor (101). In addition, infrared transmitters (103) and a calibration laser (104) are shown. The distance between sensors is calculated so that phase differentials can be obtained within a single cycle of an ultrasonic tone.

FIG. 2 is a depiction of a detector/emitter installed on a portable device. The infrared detector (200) captures an infrared message from the present system and the ultrasonic emitter (201) sends an ultrasonic tone back to the present invention.

FIG. 3 is a depiction of an embodiment of the present invention wherein an example of an immersive simulation system (in this embodiment a dome) and the present invention's location within the immersive simulation system (300). The cone-shaped area of interest (301) is depicted in this illustration as well as the portable devices (302) in use by trainees.

FIG. 4 illustrates the eye-point view problems in immersive simulation systems if tracking data is not available.

FIG. 5 is a depiction of the communication between a portable device (for example a simulated military device [SMD]) (501) and invention sensor array (500). Initially, the system will send an infrared coded burst to all portable devices in the area of interest. Then only the portable device with the matching unique identifier will emit an ultrasonic tone to the present invention.

FIG. 6 is a depiction of an ultrasonic tone reaching invention sensor array. The ultrasonic tone is arriving from in front of the sensor location (toward, for example, a dome) and to the right (if facing the dome). First, the tone will reach, for example, the Y axis sensor (602). Eventually, the tone will reach, for example, the Reference sensor (600). The difference in timer counters between when the tone reaches the Y axis sensor (602) to when the tone reaches the Reference sensor (601) is used to calculate a Y axis offset. In the depiction, the tone reaches the Reference sensor (600) before it reaches the X axis sensor (601), the timer counter difference calculation is just reversed. The Reference sensor (600) also serves as the Z axis sensor by measuring the time-of-flight from the moment the infrared code is transmitted to when the ultrasonic tone is received.

FIG. 7 is a simplified depiction of an exemplary immersive simulation system. The simulation system contains a dome (700), multiple rear-mounted image projectors (703), multiple simulated military devices (SMDs) (701), the present invention (702), multiple Projector Image Generators (IGs) (704), multiple SMD Image Generators (IGs) (705), and controller systems (706). The SMDs receive images from the SMD IGs via HDMI protocol (707). The SMDs also communicate with the controller system and the present invention via high-speed Ethernet (708). The Projector IGs send images to the projectors via HDMI protocol (709). The controller systems communicate with the Projector IGs and the SMD IGs via high-speed Ethernet (710).

FIG. 8 is a depiction of calculations to determine the intersection between an offset display vector and the dome for the X and Y axes.

FIG. 9 is a depiction of calculations to determine the intersection between an offset display vector and the dome for the Z axis.

FIG. 10 is a depiction of a phase differential for a single wave cycle of an ultrasonic tone as it is detected by the sensor array in the example depicted in FIG. 6. The sensor array for example detects the ultrasonic wave on the rising edge of the wave. Initially the ultrasonic wave is detected by the Y-axis sensor (1001) (or 602 in FIG. 6) and a sample of a sensor array processor counter is taken (1004). As the same wave cycle moves across the sensor array it is next detected by the reference sensor (1002) (or 600 in FIG. 6) and a sample of a sensor array processor counter is taken (1005). The Y-axis phase differential is the reference sensor sample (1005) less the Y-axis sensor sample (1004). The same wave cycle is then detected by the X-axis sensor (1003) (or 601 in FIG. 6) and a sample of a sensor array processor counter is taken (1006). The X-axis phase differential is the X-axis sensor sample (1006) less the reference sensor sample (1005). Phase differentials are taken for multiple wave cycles in an ultrasonic tone to provide averaging for the X and Y axis phase differentials.

For both the X and the Y axis calculations, the phase differentials for example are phase angle calculations. In this case, the phase angle differential is calculated and used to determine the angle of arrival of the signal, thereby allowing for determination of X and Y positions. The phase angle is the change (horizontal shift) between the samplings of the X or Y axis sensors and the reference sensor or the phase angle differential.

### DETAILED DESCRIPTION OF THE INVENTION

The instant system is described in further detail with respect to the enclosed Figures. The following detailed description of the Figures enclosed herewith further illustrate the invention but should not be construed as in any way limiting its scope.

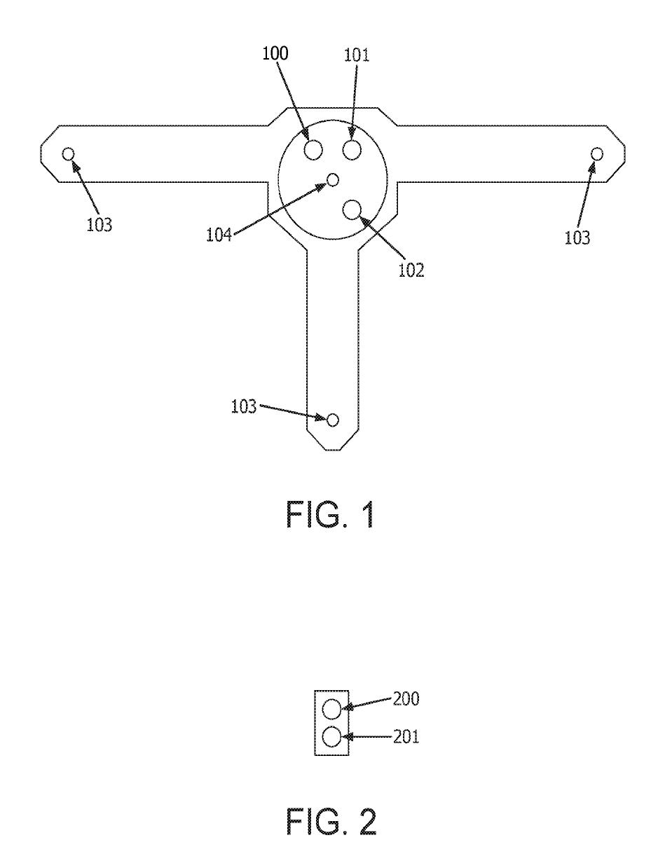

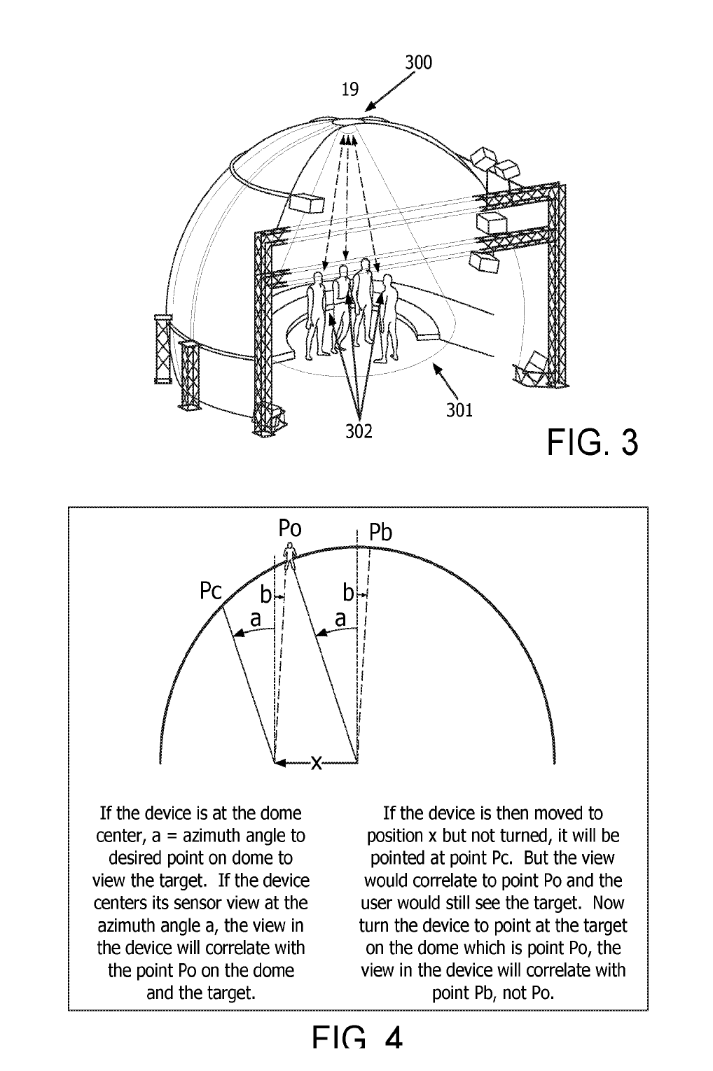

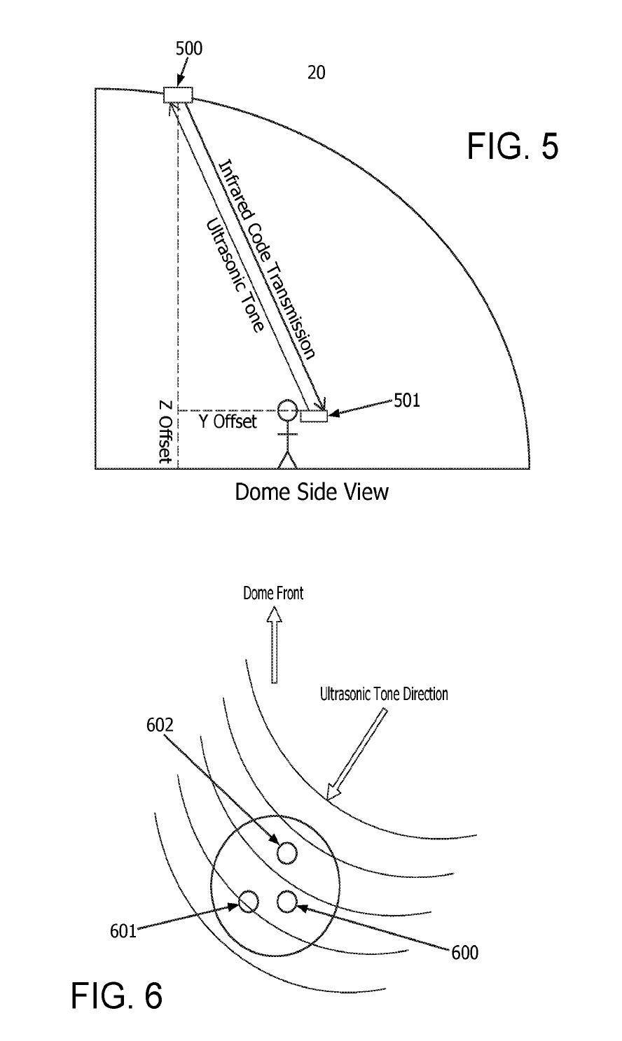

FIG. 1 illustrates an exemplary configuration of the present invention. Sensors are arranged in a pattern so as to allow a measured time difference between the arrival of an ultrasonic tone to the X axis sensor (100) and a Reference sensor (101), and a measured time difference between the arrival of an ultrasonic tone to the Y axis sensor (102) and the Reference sensor (101). In this embodiment, the Reference sensor (101) can double as the Z axis sensor. The dimension between the ultrasonic sensors can be set to be the smallest resolvable wavelength of an ultrasonic tone response from the portable devices. Also depicted are infrared emitters (103) which are configured to give maximum range on the infrared transmission within the immersive simulation system. According to this exemplary embodiment, all 3 infrared emitters (103) will emit the same code at the same time. FIG. 3 illustrates the location of the present invention (300) within an immersive simulation system.

In FIG. 2, each portable device (for example simulated military device [SMD]) is configured with one or more infrared receivers (200) and ultrasonic transmitters (201).

FIG. 3 illustrates invention sensor array in an immersive simulation system. The sensor array (300) detects the location of portable devices (for example Simulated Military Devices [SMD]) devices (302) within a specified area (in this example a cone-shaped field of interest in the dome) (301) to provide positional data used to modify the SMD's perspective (eye point offset). Positional data from a SMD display's view and/or the SMD's position within the dome (i.e., the simulated origination of tracer fire from a hand weapon) are coordinated with the Image Generator (IG) so that the view point through the visual SMD device is coordinated with the same view point that is seen with the naked eye in the dome. As SMDs are being operated, users can look left/right, up/down, and can tilt the device left/right. The images provided for the SMDs' displays are generated by independent Image Generators (IGs) and the images change to reflect the orientation (attitude) of each SMD, as controlled by infrared and ultrasonic transmit and receive signals.

Described herein is an immersive simulation system which contains sensor array that is mounted, for example, at the top of a dome over a center of the area of interest (an area of interest is the cone-shaped field around the floor of the immersive simulation system) and one or more ultrasonic transmitters and infrared receivers (see FIG. 2) embedded in each SMD that requires positional data. Information from the sensor array is fed to individual SMD processing units to adjust the IG view within each SMD device. Some SMD devices, because of the way they are used, require more than one set of transmitters (201) and receivers (200). FIG. 4 illustrates the purpose of providing positional offsets to SMDs in an immersive simulation system. Without a tracking system, the point-of-view at a particular orientation would be the same at different positions within the immersive simulation system.

Each portable device (for example SMD) configured in an immersive simulation system (for example dome) is assigned a unique identifier (Tracking ID). A processor configured with the present invention will schedule each Tracking ID to be sampled in a priority-based scheduling algorithm. The processor configured with the present invention will create a message to contain the Tracking ID of the SMD to be sampled and a “Send Ultrasonic Tone” command. The present invention will transmit this message to all SMDs in the immersive simulation system (dome) as an 8-bit infrared code. At the same time, the sensor measurement timers in the present invention processor are reset to 0 and set to run. Upon receiving the infrared command, each SMD will compare the Tracking ID from the infrared command with their unique identifier. If they match, only that SMD will emit an ultrasonic tone. FIG. 4 illustrates an embodiment of the described system (500) emitting an infrared message, and the SMD (501) responding with an ultrasonic tone.

The processor configured with the described system is programmed to record a multitude of timer values when the ultrasonic tone is sensed for each of the 3 ultrasonic sensors. The processor measurement timers are sampling at a rate of, for example, 80 MHz (or every 12.5 nsec). The X axis sensor (100) timer value is subtracted from the Reference sensor (101) timer value to create the X axis phase differential. The Y axis sensor (102) timer value is subtracted from the Reference sensor (101) timer value to create the Y axis phase differential. The timer value associated with the Reference sensor will be used for the Z axis calculation.

A configurable scaling factor is applied to X and Y axis differentials to scale the differential values to a centimeter (1 differential unit=1 centimeter). These X and Y axis offsets are then forwarded to the specific SMD processor for incorporation into the SMD's display eye-point view.

The Z axis position can be calculated as a time-of-flight value from the SMD to the sensor array. Initially, the Z time-of-flight value is subtracted from the number of timer units from the sensor to the floor of the dome (the floor distance is determined during a calibration phase). This calculation is the number of timer units from the floor of the dome to the SMD. A configurable scaling factor is applied to the Z axis offset to scale the offset from timer units to centimeters. The Z axis offset is then forwarded to the SMD for incorporation into the SMD's display eye-point view.

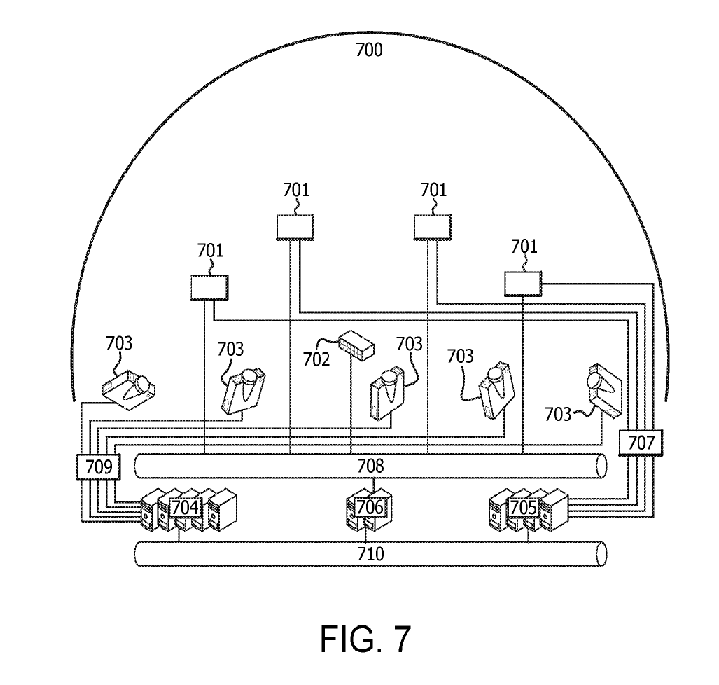

FIG. 7 depicts a simplified immersive simulation system. An immersive simulation system in this exemplary embodiment contains a dome (700), multiple rear-mounted projectors (703) controlled by multiple Image Generators (IGs) (704), the IGs send display information to the projectors via HDMI protocol (709). Also included in this immersive simulation system are SMDs (701), the SMD displays are controlled by SMD IGs (705), and a series of controller systems (706). The SMD IGs send display data to the SMD displays via HDMI protocol (707). The controller systems (706), the Projector IGs (704) and the SMD IGs (705) communicate via high-speed Ethernet (710). The controller systems also make requests of the SMDs and the present invention via high-speed Ethernet (708).

The Projector IGs (704) generate the scenery of a simulated topical location for displaying on the dome (700). The SMD IGs (705) generate an immersive simulation image of the dome from the perspective of the SMD. The SMD IGs create an eye-point image of the dome image based on the position and orientation of the SMD. The present invention adjusts the SMD eye-point image, at any location within the area of interest in the immersive simulation system, to match the dome image.

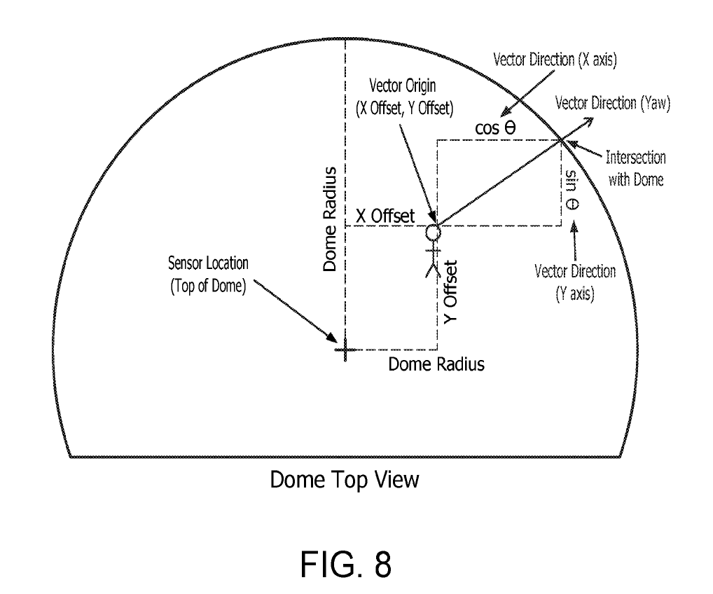

After the present invention has completed calculating the position offset (in the X, Y and Z axes) for a particular SMD, it will send the tracking data to the SMDs. The specific SMD processors will use the current display vector (using the yaw and pitch orientation of the SMD), and the new tracking offset to calculate new coordinates where the offset display vector intersects with the dome. FIG. 8 illustrates the calculations required for the new display vector intersection with the dome. A person skilled in the art of polynomial mathematics can understand the dome intersection calculations.

$$Dome intersection$$

$$x = \frac{- b \pm \sqrt{{b}^{2} - 4 ac}}{2 a}$$

$$Where \text{:}$$

$$a = Vector Direction \cdot {x}^{2} + Vector Direction \cdot {y}^{2} + Vector Direction \cdot {z}^{2}$$

$$b = 2 ( Vector Direction \cdot x ) ( Vector Origin \cdot x ) + 2 ( Vector Direction \cdot y ) ( Vector Origin \cdot y ) + 2 ( Vector Direction \cdot z ) ( Vector Origin \cdot z )$$

$$c = Vector Origin \cdot {x}^{2} + Vector Origin \cdot {y}^{2} + Vector Origin \cdot {z}^{2}$$

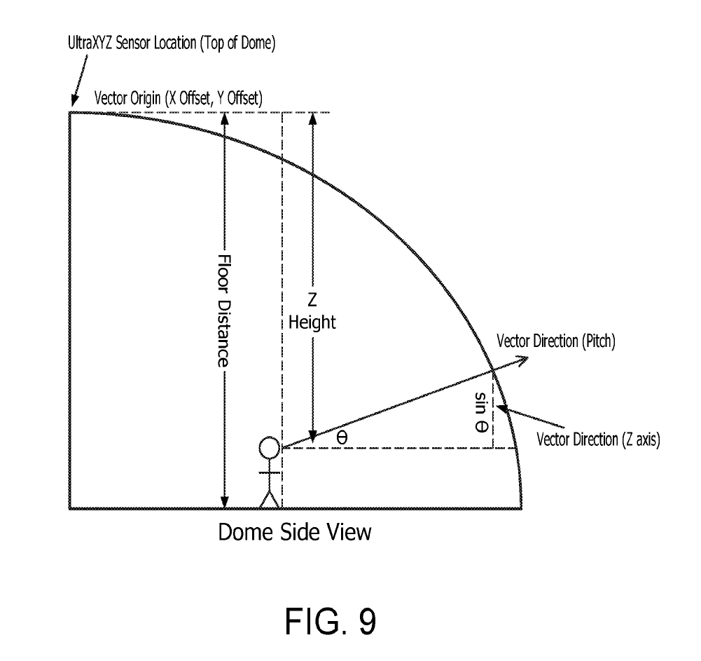

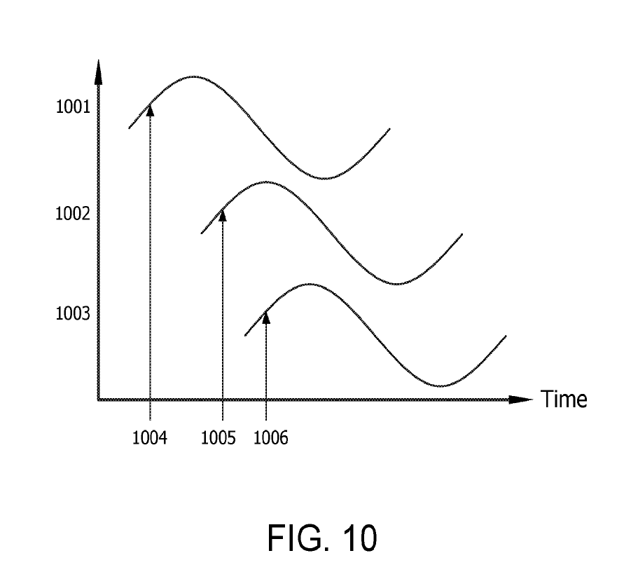

FIG. 9 illustrates the position offset calculations required for the Z axis. The number of sensor units from the present invention to the floor is calculated during calibration of the sensor array. The Z height of the SMD is subtracted from the floor distance resulting in the height of the SMD above the floor. This value is scaled by a configurable scaling factor to result in 1 sensor unit equaling 1 centimeter. The Z axis information is included in the quadratic equation above.

The Controller Systems (706) request the orientation data (yaw, pitch and roll), the tracking data (X, Y and Z axis offsets), and the newly calculated adjusted orientation (offset yaw, pitch and roll) from each SMD and forwards this information onto the SMD IG responsible for a particular SMD's display. The responsible SMD IG uses the adjusted orientation data to create an image of the dome from the perspective of the SMD's eye-point and transmits this image to the SMD's display via HDMI (707).

This process occurs multiple times a second for all SMDs registered in the immersive simulation system.

Although more specifically described above are immersive simulation systems, the described position tracking systems potentially have application outside of the simulation genre. Multiple sensor arrays can be configured to increase the size of the area of interest. Further, although a simulated military environment is discussed above, it would be understood that the described position tracking system could be used in differing simulation environments. Although the SMDs in the immersive simulation system may be tethered, wireless portable devices can be developed, drawing minimal power, to allow for a more free range of movement.

While the exemplary embodiments described above include specifically a dome, it would be understood that the system could potentially be adapted to any three dimensional immersive environment.

“Simulated Military Devices” as used throughout would be any portable device used in a simulated military environment, including but not limited to portable devices such as binoculars for observing distant locations, or other simulated devices which normally would be used by a soldier in a typical military environment.

“Portable devices” as used throughout would by any device which is moveable and for which it is desirable to track the position. While described in more detail above are simulated military devices, it is understood that the instantly described system could be used to track any portable device fitted with an ultrasonic transmitter.

“Immersive simulation system” is any system which allows for three dimensional immersion in a simulated environment. While immersive military simulation environments are described in more detail above, it is understood that the system may be used in other immersive systems. Further, while immersive simulation systems described in more detail above are in the shape of a dome, it is understood that the instantly described system could be configured for use in other three dimensional geometries.

“Ultrasonic transmitter” is a transmitter which is capable of emitting an ultrasonic tone. An ultrasonic tone is a tone which has a frequency above the human ear's adubility limit of 20,000 hertz, for example 40 kHz.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1. An immersive simulation environment, comprising system for tracking the location of a portable device, comprising:
a portable device comprising an ultrasonic transmitter and a detector;
a stationary sensor array comprising at least three ultrasonic sensors in communication with a sensor array processor; and
at least one emitter;
wherein the at least one emitter is configured to send a signal to the portable device;
wherein the portable device is configured to emit an ultrasonic tone when the detector receives the signal;
wherein the at least three ultrasonic sensors are configured to receive the ultrasonic tone; and
wherein the sensor array processor is configured to calculate differentials and the order in which the at least three ultrasonic sensors receive the ultrasonic tone to calculate the x-position and the y-position of the portable device through a phase angle calculation;
wherein the immersive simulation environment is in the shape of a dome.

2. The immersive simulation environment according to claim 1, wherein the sensor array processor is further configured to start a counter when the emitter sends the signal and stop the counter when a number of samples per tone reaches a sensor in the array to determine the z-position of the portable device.

3. The immersive simulation environment according to claim 2, wherein the portable device further comprises an accelerometer/gyroscope/compass device.

4. The immersive simulation environment according to claim 1, wherein the stationary sensor comprises three ultrasonic sensors, comprising an x-axis sensor, a y-axis sensor, and a reference sensor.

5. The immersive simulation environment according to claim 1, wherein the at least one emitter is located on the stationary sensor array.

6. (canceled)

7. (canceled)

8. The immersive simulation environment according to claim 1, wherein the stationary sensor array is located at the top center of the dome.

9. The immersive simulation environment according to claim 1, wherein the immersive simulation environment is a simulated military environment.

10. The immersive simulation environment according to claim 9, wherein the portable device is a simulated military device.

11. The immersive simulation system comp stem according to claim 1, comprising at least two rear-mounted image projectors, and at least two projector image generators, at least two SMD image generators, wherein the portable devices receive images from the SMD image generators.

12. A method for tracking the position of a portable device comprising an ultrasonic transmitter and a detector in an immersive simulation system comprising a stationary sensor array comprising at least three ultrasonic sensors in communication with a sensor array processor, and at least one emitter; the process comprising:
sending a signal from the at least one emitter to the portable device;
emitting an ultrasonic tone from the portable device when the detector receives the signal;
receiving at the at least three ultrasonic sensors the ultrasonic tone; and
calculating in the sensor array processor phase differentials and the order in which the at least three ultrasonic sensors receive the ultrasonic tone to determine the x-position and the y-position of the portable device through a phase angle calculation;
wherein the immersive simulation system is in a dome, wherein the stationary sensor array is mounted at the top center of the dome, and the portable device is located inside of the dome.

13. The method according to claim 12, further comprising:
starting a counter at the sensor array processor when the sensor array emits an infrared burst and stopping the counter when a number of samples per tone reaches a sensor in the array to determine the z-position of the portable device.

14. (canceled)

15. The method according to claim 12, wherein the at least one emitter is located on the stationary sensor array.

16. The method according to claim 15, wherein the stationary sensor array comprises three sensors, an x-axis sensor, a y-axis sensor, and a reference sensor.

17. The method according to claim 16, wherein the processor is programmed to record a multitude of timer values when the ultrasonic tone is sensed for each of the three ultrasonic sensors; and wherein the x-position and y-position calculation comprises:
subtracting the x axis sensor timer value from the reference sensor timer value to create an x axis differential;
subtracting the y axis sensor timer value from the reference sensor timer value to create a y axis differential; and
applying a configurable scaling factor to the x-axis differential and the y-axis differential to determine x-axis and y-axis offsets for the portable device.

18. The method according to claim 12, wherein the detector is configured to detect a radio signal or an infrared emission and the at least one emitter is configured to emit a radio signal or an infrared emission.

19. The method according to claim 18, wherein the detector is an infrared detector and the at least one emitter is an infrared emitter.

20. The system according to claim 1, wherein the detector is configured to detect a radio signal or an infrared emission and the at least one emitter is configured to emit a radio signal or an infrared emission.

21. The system according to claim 1, wherein the detector is an infrared detector and the at least one emitter is an infrared emitter.
